(19) United States
(12) Patent Application Publication
(10) Pub. No.: US 2010/0257360 A1
(43) Pub. Date: Oct. 7, 2010

(54) METHOD AND APPARATUS FOR PROTECTING ILLEGAL PROGRAM COPY OF MOBILE COMMUNICATION TERMINAL

(75) Inventors: Hyungdeug Bae, Daejon (KR); Namhoon Park, Daejon (KR); Jinup Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/742,523

(22) PCT Filed: Aug. 28, 2008
(86) PCT No.: PCT/KR2008/005047

§ 371 Date: May 12, 2010

(30) Foreign Application Priority Data
Nov. 12, 2007 (KR) 10-2007-0114659

(51) Int. Cl. H04L 9/32

(52) U.S. Cl. 713/168

(57) ABSTRACT

A provider of the mobile communication program obtains the public key generated on the basis of a unique terminal identification number (IMEI) unique to an SDR terminal by a key generation algorithm, registers the generated public key in a key registration server, encrypts a mobile communication program with the public key, and distributes the encrypted program. The SDR terminal generates the private key on the basis of the unique terminal identification number (IMEI) by the key generation algorithm, decrypts the encrypted program downloaded from a server with the generated private key, and installs and operates the decrypted program. Since the mobile communication program is encrypted, although a third person tries to install an illegal copy program in an SDR terminal, the decryption is impossible, and the installation becomes impossible. In addition, it is possible to prevent ill-intentioned corruption and illegal reuse of an illegal copy program by the third person.

### TECHNICAL FIELD

The present invention relates to a method and apparatus for protecting illegal program copy, and in particular, to a method and apparatus for protecting illegal program copy of an SDR (Software Defined Radio) terminal.

This work was supported by the IT R&D program of MIC/IITA [2006-S-012-02, Development of Middleware Platform Technology Based on the SDR Mobile Station].

### BACKGROUND ART

In a known mobile communication terminal, software and hardware are implemented to be integrated, such that it is impossible to support a new communication system newly added by software. In case of an SDR (Software Defined Radio) terminal, however, mobile communication software can be dynamically installed and uninstalled with respect to a hardware platform. Therefore, the SDR terminal can support a new communication system by software.

In the existing mobile communication terminal, various systems and methods of protecting illegal program copy have been used.

As the systems and methods for illegal copy protection, there are known a method that protects illegal copy by complicating an access procedure to a program using multiple processors, and a method that protects illegal copy by attaching specific hardware to a terminal for illegal copy protection.

For example, there are known techniques for illegal copy protection using a hardware key lock and techniques for illegal copy protection using software. The techniques for illegal copy protection by software include a method that limits the number of installations by recording installation information, and a method that distributes password information for installation separately from a disc, or changes password information as occasion demands.

However, the systems and methods for illegal copy protection have a few drawbacks.

In case of the technique that protects illegal copy by attaching the hardware key lock to the system, if the hardware key lock is lost, it is not easy for a user to obtain a substitute for the hardware key lock.

In case of the method for illegal copy protection using software, a user may use a copy of a program when needed without using the program itself, and accordingly illegal copy may not be inhibited. In addition, even if the user cannot copy the program, he/she may open the password to the public. In this case, there is no way to prevent the password from being opened to the public.

As another method for illegal copy protection, there is known a method that uses unique hardware information installed in a chip of a program ROM, in which a system program of a mobile phone is installed. This method permits a copy of the program with respect to the same unique hardware information. Otherwise, copy is inhibited. Meanwhile, a hacker may find out hardware setting determination codes for illegal copy protection through try error loops, which cracks the program sector by sector. Accordingly, even in a mobile phone, in which hardware secret parameters for illegal copy protection are set, it may be possible to manipulate the hardware secret parameters such that a normal determination value is output.

The above-described methods have been designed for illegal copy protection of the existing mobile communication terminals, and consequently there are a few drawbacks in respect to applying them to the SDR terminal. First, since the SDR terminal has a structure that can easily copy, install, and uninstall a program, compared with the existing terminals, the above-described methods cannot protect the contents of the program. That is, since the machine hexadecimal codes of an illegal copy program in the SDR terminal may be decoded by the hacker, ill-intentioned corruption and illegal reuse of the program may not be inhibited.

FIG. 1 is a flowchart illustrating a method for illegal copy protection in a known mobile communication terminal. The method for illegal copy protection of a program, which is operated between a mobile communication terminal and a base station, includes the steps of: determining presence/absence of hardware setting for illegal copy protection in a state where the mobile communication terminal is turned on; if illegal copy is found, displaying occurrence of illegal copy on an LCD and stopping the operation of the program, and if illegal copy is not found, operating a mobile communication protocol to receive a network code of the base station; if the network code of the base station is received, confirming whether or not the network code corresponds to a country or network where illegal copy frequently occurs; when the network code does not correspond to the country or network where illegal copy frequently occurs, operating a timer to check the hardware setting for illegal copy protection at given intervals; when the network code corresponds to the country or network where illegal copy frequently occurs, moving a distributed/encrypted illegal copy check program to any available space with any frame number received from the network as a random number; and determining whether or not a check by a hardware check routine for illegal copy protection, which is newly combined by the distributed/encrypted illegal copy check program moved to any available space, is normal, if the check is not normal, notifying the occurrence of illegal copy and stopping the operation of the program, and if the check is normal, operating the timer to check the hardware setting for illegal copy protection at given intervals.

In the SDR (Software Defined Radio) terminal, a wireless mobile communication system to be used is determined according to the kind of program installed on the hardware platform. Accordingly, the wireless mobile communication system of the SDR terminal correspondingly changes when a program is installed and uninstalled. At this time, the SDR terminal should prevent illegal copy of a mobile communication program from being installed and operated. In addition, since the mobile communication program is stored, installed, and operated in a nonvolatile memory area of the SDR terminal, illegal copy may easily occur.

Therefore, the SDR terminal should prevent machine codes of an illegal copy program from being opened to a third person, thereby preventing ill-intentioned corruption and illegal reuse of the program.

### DISCLOSURE OF INVENTION

### Technical Problem

The invention has been finalized in order to solve the above-described problems. It is an object of the invention to provide a method and apparatus for protecting illegal program copy of a mobile communication terminal, which generates a public key and a private key on the basis of hardware setting information unique to an SDR terminal, encrypts a mobile communication program with the public key and distributes the encrypted mobile communication program, and decrypts, installs, and operates the encrypted mobile communication program with the private key generated on the basis of the hardware setting information of the SDR terminal and installs, thereby protecting illegal copy of the program of the SDR terminal and preventing an infringement of copyright.

### Technical Solution

According to an aspect of the invention, there is provided a method of protecting illegal program copy of a mobile communication terminal. The method includes the steps of: (a) causing the mobile communication terminal to generate a public key on the basis of hardware setting information thereof by a key generation algorithm; (b) causing the mobile communication terminal to register the generated public key in a key registration server; (c) causing the mobile communication terminal to request the download of a desired program from a program download server; (d) causing the mobile communication terminal to download a program, which is encrypted with the public key of the mobile communication terminal registered in the key registration server, from the program download server; and (e) causing the mobile communication terminal to generate a secret key on the basis of the hardware setting information thereof by the key generation algorithm, and to decrypt the downloaded encrypted program with the generated secret key.

According to another aspect of the invention, there is provided a method of protecting illegal program copy of a mobile communication terminal. The method includes the steps of: (a) causing a program download server to receive a request to download a program from the mobile communication terminal; (b) causing the program download server to receive a public key, which is generated on the basis of hardware setting information of the mobile communication terminal, from a key registration server; (c) causing the program download server to encrypt the program requested by the mobile communication terminal with the received public key; and (d) causing the program download server to transmit the encrypted program to the mobile communication terminal.

According to still another aspect of the invention, there is provided an apparatus for protecting illegal program copy of a mobile communication terminal. The apparatus includes: a key generation algorithm unit that reads hardware setting information of the mobile communication terminal, and generates a secret key and a public key on the basis of the read hardware setting information; a key registration unit that registers the generated public key in a key registration server; and a decryption unit that decrypts a program, which is encrypted with the public key registered in the key registration server and downloaded from the program download server, with the generated secret key.

### Advantageous Effects

According to the aspects of the invention, a public key and a private key are generated on the basis of hardware setting information (IMEI: International Mobile Equipment Identity) unique to an SDR terminal, which is attracting attention as a future mobile communication technology, by a key generation algorithm. The public key is registered in a key registration server. A program is encrypted with the public key by a program provider and distributed. The encrypted program is decrypted with the private key, which is generated on the basis of the hardware setting information of the SDR terminal by the key generation algorithm. Therefore, illegal program copy in SDR terminals can be protected, and an infringement of copyright can be prevented.

According to the aspects of the invention, a program install and uninstall process is provided, and use of an illegal copy program in the mobile communication terminal is completely inhibited by an asymmetric key encryption/decryption algorithm. Therefore, an infringement of copyright can be prevented.

According to the aspects of the invention, the mobile communication program is encrypted, thereby preventing ill-intentioned corruption and illegal reuse of the program by a third person. Therefore, the third person cannot know the contents of the encrypted mobile communication program, and thus he/she cannot change the contents or use the contents for other purposes. Particularly, an error in the communication infrastructure, such as disturbance of a mobile communication system, due to the use of a program having ill-intentioned codes in a general-use computer, in which the program can be stored, installed, and uninstalled, can be prevented from occurring. In addition, by encrypting the mobile communication program, the confidentiality of the program codes can be secured, thereby preventing ill-intentioned use by the third person.

### BRIEF DESCRIPTION OF THE DRAWINGS

FIG. 1 is a flowchart illustrating a technology for illegal copy protection in a known mobile communication terminal.

FIG. 2 is a diagram showing a key generation process using hardware setting information unique to an SDR terminal according to an embodiment of the invention.

FIG. 3 is a diagram showing a process of transmitting a terminal public key according to an embodiment of the invention.

FIG. 4 is a diagram illustrating a process of encrypting a program with a public key according to an embodiment of the invention.

FIG. 5 is a diagram illustrating a process of decrypting an encrypted program with a secret key (private key) in an SDR terminal according to an embodiment of the invention.

FIG. 6 is a diagram showing the configuration of a system for decrypting an encrypted program in an SDR terminal.

FIG. 7 is a flowchart illustrating a process of reading hardware setting information and decrypting an encrypted program with a secret key in an SDR terminal according to an embodiment of the invention.

FIG. 8 is a diagram illustrating the functional elements of a mobile communication program for an SDR terminal.

### DESCRIPTION OF REFERENCE NUMERALS AND SIGNS

101: HARDWARE SETTING INFORMATION

102: KEY GENERATION ALGORITHM

103: PUBLIC KEY

104: SECRET KEY (PRIVATE KEY)

201: KEY REGISTRATION SERVER

202: TERMINAL

203: PROGRAM DOWNLOAD SERVER

301: MOBILE COMMUNICATION PROGRAM

303: ENCRYPTED MOBILE COMMUNICATION PROGRAM

401: DECRYPTION PROGRAM

402: DECRYPTED MOBILE COMMUNICATION PROGRAM

501: SDR TERMINAL INSTALL PROGRAM

502: KEY GENERATION ALGORITHM UNIT

503: KEY REGISTRATION UNIT

504: DECRYPTION UNIT

### BEST MODE FOR CARRYING OUT THE INVENTION

In the following detailed description, only certain exemplary embodiments of the present invention have been shown and described, simply by way of illustration. As those skilled in the art would realize, the described embodiments may be modified in various ways, all without departing from the spirit or scope of the present invention.

Hereinafter, a preferred embodiment of the invention will be described in detail with reference to the accompanying drawings.

FIG. 2 is a diagram showing a key generation process using hardware setting information unique to an SDR terminal according to an embodiment of the invention.

An asymmetric key algorithm according to an embodiment of the invention uses an encryption key and a decryption key different from each other. That is, the asymmetric key algorithm uses a public key for encryption, and a private key or a secret key for decryption.

Hardware setting information 101 is information, such as a unique terminal identification number (IMEI: International Mobile Equipment Identity) unique to a mobile communication terminal (hereinafter, simply referred to as “terminal”), which has a size of 45 bits and secures confidentiality. The IMEI includes a TAC (Type Approval Code) that represents information about type approval of the corresponding terminal, an FAC (Final Assembly Code) that identifies a company, which produces the corresponding terminal, an SNR (Serial NumbeR) that is a unique serial number of the corresponding terminal, and a CD (Check Digit) that is used to check presence/absence an error in the unique terminal identification number.

The terminal is an SDR (Software Defined Radio) terminal.

A key generation algorithm 102 receives the hardware setting information (IMEI) 101 unique to the SDR terminal, and generates a pair of a public key 103 and a secret key (private key) 104. At this time, the SDR terminal generates the public key 103 and the secret key 104 on the basis of the hardware setting information 101 by the key generation algorithm 102, and registers the generated public key in the key registration server.

A provider of a mobile communication program encrypts the mobile communication program with the public key 103 registered in the key registration server, and distributes the encrypted mobile communication program. The SDR terminal generates the secret key (private key) 104 on the basis of the hardware setting information 101 by the key generation algorithm 102, and decrypts the encrypted program downloaded from a program download server with the secret key (private key) 104, and installs the decrypted program.

In the SDR terminal according to an embodiment of the invention, a method of protecting illegal program copy uses an asymmetric encryption/decryption algorithm.

In general, an asymmetric encryption technology (hereinafter, referred to as “public key encryption technology”) performs authentication, signature, and encryption with a public key and a private key, and has been recently widely used because an encryption key and a decryption key are different from each other, thereby realizing ease of key distribution. The public key encryption technology includes RSA (Rivest, Shamir, Adlman), ECC (Elliptical Curve Cryptogram), and the like. The RSA algorithm has been recently used as the public key encryption algorithm. However, in the RSA algorithm, a large amount of computation is required for encryption and decryption and a processing speed is low. Accordingly, it is difficult to apply the RSA algorithm to a mobile communication apparatus or a PDA (Personal Digital Assistant).

The public key encryption/decryption algorithm for protecting illegal program copy of the terminal according to an embodiment of the invention uses EC-KCDSA (Korean Certificate-based Digital Signature Algorithm using Elliptic Curves). The EC-KCDSA algorithm is an asymmetric algorithm that is established as Korean Information Communication Standard on Dec. 19, 2001 (TTAS.KO-12.0015).

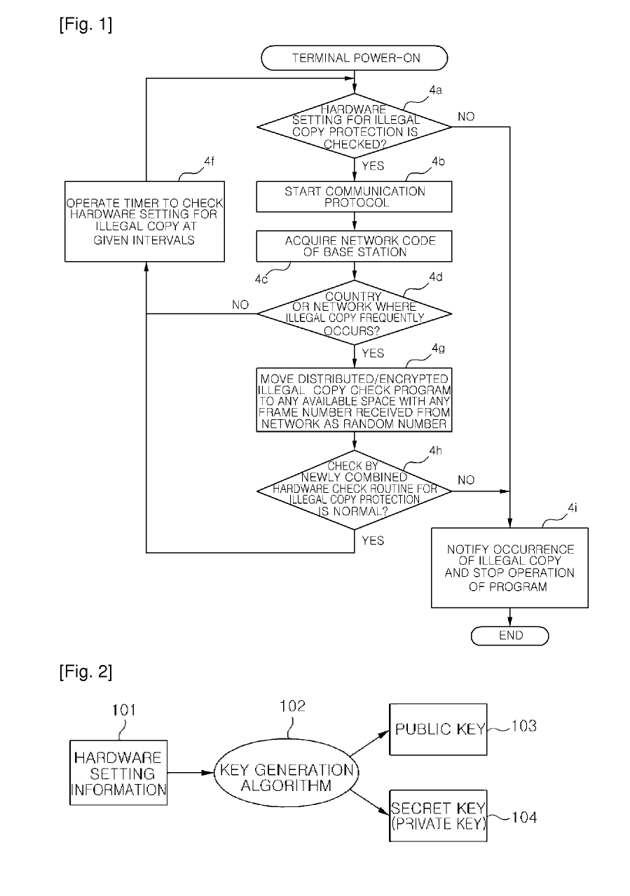

The public key and the private key that are generated in the SDR terminal by the key generation algorithm 102 may be represented by the following Math Figure 1.

<Math Figure 1>

X_{A}=f(IMEI) (1)

Y_{A}=X_{A}*P (2)

Here, X_{A} denotes a private key of a terminal A, Y_{A} denotes a public key of the terminal A, and P denotes a point on an elliptical curve E.

As represented by (1) of the Math Figure 1, the private key X_{A} 104 of the terminal A is generated by the key generation algorithm 102 using the unique terminal identification number (IMEI) as a variable. A user of the SDR terminal registers the terminal public key 103 generated by the key generation algorithm 102 in a key registration server 201.

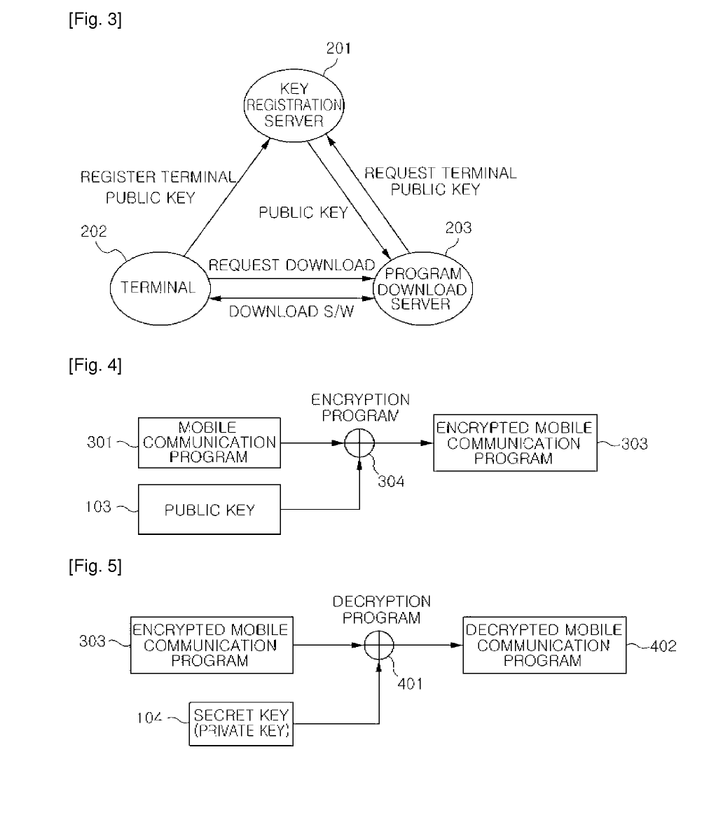

FIG. 3 is a diagram showing a process of transmitting a terminal public key according to an embodiment of the invention.

First, the terminal 202 registers its own public key 103 generated on the basis of the unique terminal identification number (IMEI: International Mobile Equipment Identity) in the key registration server 201.

If the terminal 202 requests the download of a program from a program download server 203, the program download server 203 requests the key registration server 201 for the public key 103 of the corresponding terminal.

The program download server 203 of the provider of the mobile communication program receives the public key 103, which is generated on the basis of the hardware setting information unique to the terminal, from the key registration server 201. Then, the program download server 203 encrypts software to be downloaded with the public key 103 of the terminal and transmits the encrypted mobile communication program to the terminal 202.

The terminal 202 generates the secret key (private key) on the basis of the hardware setting information by the key generation algorithm 102. Then, the terminal 202 decrypts the downloaded encrypted mobile communication program with the generated secret key, and stores the downloaded encrypted mobile communication program in a nonvolatile memory.

FIG. 4 is a diagram illustrating a process of encrypting a program with a public key according to an embodiment of the invention.

The program download server 203 of the provider of the mobile communication program provider acquires the public key 103 of the terminal, which is generated on the basis of the unique terminal identification number (IMEI: International Mobile Equipment Identity), from the key registration server 201, and encrypts a mobile communication program 301 by an encryption program 304.

The encryption program 304 encrypts the mobile communication program 301 with the public key 103 of the terminal, and outputs an encrypted mobile communication program 303.

The program download server 203 encrypts the mobile communication program 301 with the public key 103, and transmits the encrypted mobile communication program 303 to the terminal 202.

In the encryption program 304, a public key encryption method, which is currently in common use, is used as an encryption method. Here, a description will be given by way of an EC-KCDSA algorithm.

To transmit a message M=(m1, m2) to the terminal 202, the program download server 203 selects an integer k, and calculates a point kP and a point k(X_{A}P) using a point P on an elliptical curve.

<Math Figure 2>

c₀=kP (1)

k(X_{A}P)=X_{A}(kP)=(x,y) (2)

In (2) of the Math Figure 2, when the values x and y are not 0, the values c₁ and c₂ are calculated as represented by the following Math Figure 3.

<Math Figure 3>

c₁=m₁·x (1)

c₂=m₂y (2)

The program download server 203 crates a cryptogram C={c₀,c₁,c₂} using the result values calculated by the Math Figure 2 and 3, and transmits the created cryptogram to the terminal 202.

FIG. 5 is a diagram illustrating a process of decrypting an encrypted program with a secret key (private key) in an SDR terminal according to an embodiment of the invention.

The SDR terminal reads its own IMEI as the hardware setting information, inputs the unique terminal identification number (IMEI) to the key generation algorithm 102, and generates its own secret key 104 using (1) of the Math Figure 1.

A decryption program 401 generates the secret key of the terminal on the basis of the hardware setting information (IMEI) of the corresponding terminal by the key generation algorithm. The decryption program 401 decrypts the encrypted mobile communication program 303 stored in a USB memory or downloaded from the program download server 203 with the generated secret key (private key) 104, and provides a decrypted mobile communication program 402.

For example, when receiving the cryptogram C={c₀,c₁,c₂} from the program download server 203, the terminal 202 decrypts the cryptogram. The terminal 202 calculates (x,y) coordinates used by the program download server 203 using its own private key X_{A}. Then, the terminal 202 restores the message M={m1,m2} using the (x,y) as represented by the following Math Figure 4.

<Math Figure 4>

X_{A}·c₀=X_{A}(kP)=(x,y) (1)

m1=c₁/x=m1x/x, m2=c₂/y=m2y/y (2)

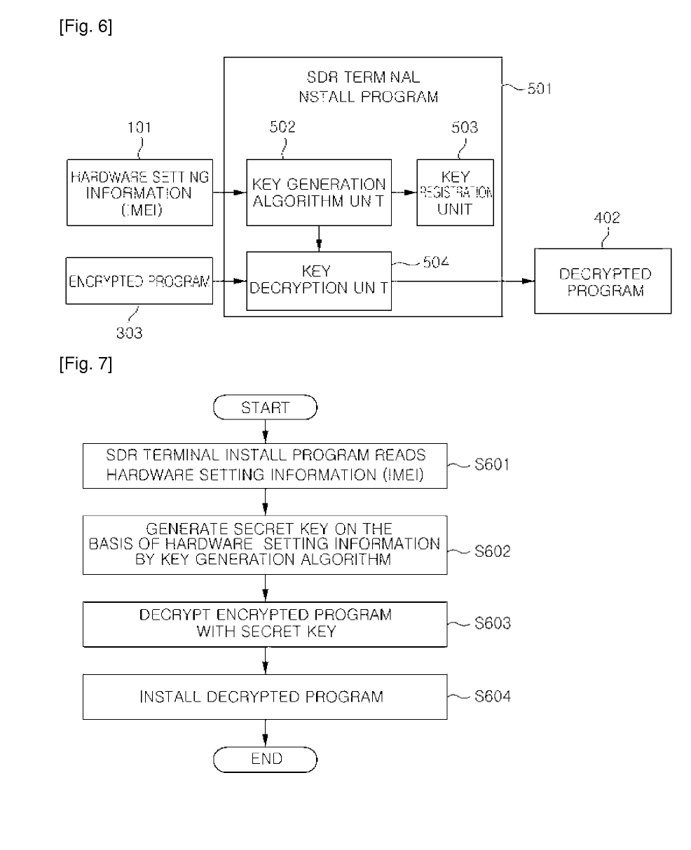

FIG. 6 is a diagram showing the configuration of a system for decrypting an encrypted program in an SDR terminal according to an embodiment of the invention.

The SDR terminal includes an SDR terminal install program 501. The SDR terminal install program 501 is composed of a key generation algorithm unit 502, a key registration unit 503, and a decryption unit 504.

The SDR terminal install program 501 includes: a key generation algorithm unit 502 that reads the hardware setting information (IMEI or unique terminal identification number) of the terminal, and generates the secret key and the public key on the basis of the hardware setting information; a key registration unit 503 that registers the generated public key in the key registration server 201; and a decryption unit 504 that decrypts the program, which is encrypted with the public key registered in the key registration server 201 and downloaded from the program download server 203, with the generated secret key.

The SDR terminal install program 501 reads the hardware setting information 101, and generates its own secret key (private key) 104 by the key generation algorithm unit 502.

The decryption unit 504 of the SDR terminal install program 501 decrypts the encrypted mobile communication program 303 with the generated secret key 104, outputs the decrypted program 402, and installs the decrypted program 402 in the terminal.

FIG. 7 is a flowchart illustrating a process of reading hardware setting information and decrypting an encrypted program with a secret key in an SDR terminal according to an embodiment of the invention.

Once the program starts to be installed in the SDR terminal, the SDR terminal install program 501 reads the hardware setting information 101 including the unique terminal identification number (IMEI: International Mobile Equipment Identity) unique to the terminal (Step S601).

The key generation algorithm unit 502 generates the secret key (private key) 104 on the basis of the hardware setting information 101 read from the SDR terminal by the key generation algorithm (Step S602).

The decryption unit 504 decrypts the encrypted mobile communication program 303, which is encrypted with the public key, with the generated secret key (private key) 104, and outputs the decrypted program 402 (Step S603).

Next, the SDR terminal install program 501 installs the decrypted program 402 in the SDR terminal (Step S604).

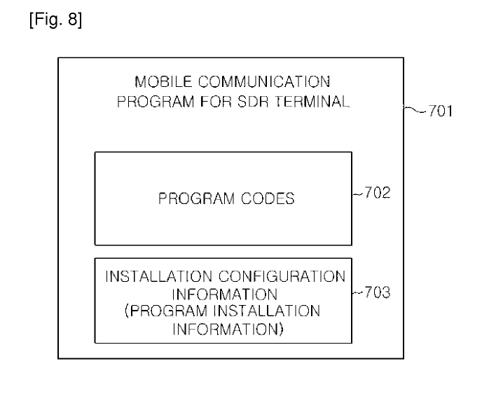

FIG. 8 is a diagram illustrating the functional elements of a mobile communication program for an SDR terminal.

According to the purposes, a mobile communication program 701 for an SDR terminal is divided into program codes 702 and program installation information (installation configuration information) 703.

The installation configuration information 703 defines how the program codes 702 are arranged and installed in various hardware chips.

The SDR terminal install program 501 first reads the installation configuration information 703, and arranges and installs the program codes 702 according to the installation configuration information 703. If the installation configuration information 703 cannot be read, the SDR terminal install program 501 cannot arrange and install the program codes 702.

The mobile communication program 701 for an SDR terminal encrypts the program codes 702 and the installation configuration information 703, thereby inhibiting the installation of an illegal copy program, and protecting the contents of the program codes.

The provider of the mobile communication program obtains the public key generated on the basis of the hardware setting information (IMEI) unique to the SDR terminal by the key generation algorithm, encrypts the mobile communication program with the generated public key, and distributes the encrypted mobile communication program. The SDR terminal generates the private key on the basis of its own unique hardware setting information (IMEI), decrypts the encrypted program with the generated private key, and installs and operates the decrypted mobile communication program.

According to the system for protecting illegal program copy of a mobile communication terminal, since the mobile communication program is encrypted, even if a third person tries to install an illegal copy program in an SDR terminal, the decryption is impossible, and thus the installation becomes impossible, thereby preventing ill-intentioned corruption and illegal reuse by the third person. Therefore, the machine codes of the program encrypted with the public key in the SDR terminal cannot be opened, thereby preventing the ill-intentioned use of the illegal copy program by the third person.

According to the invention, only an authorized SDR terminal user can install and operate the mobile communication program. Therefore, the use of an illegal copy program by a third person can be inhibited, and as a result, an infringement of copyright can be prevented.

It should be understood that the invention is not limited to the above-described embodiments, but various modifications and changes can be made without departing from the subject matter of the invention. In addition, all modifications and changes that fall within metes and bounds of the claims, or equivalents of such metes and bounds are intended to be embraced by the claims.

1. A method of protecting illegal program copy of a mobile communication terminal, the method comprising the steps of:
(a) causing the mobile communication terminal to generates a public key on the basis of hardware setting information thereof by a key generation algorithm;
(b) causing the mobile communication terminal to register the generated public key in a key registration server;
(c) causing the mobile communication terminal to request the download of a desired program from a program download server;
(d) causing the mobile communication terminal to download a program, which is encrypted with the public key of the mobile communication terminal registered in the key registration server, from the program download server; and
(e) causing the mobile communication terminal to generate a secret key on the basis of the hardware setting information thereof by the key generation algorithm, and to decrypt the downloaded encrypted program with the generated secret key.

2. The method as set forth in claim 1, wherein the step (e) includes the substeps of:
(e1) reading the hardware setting information by a mobile communication terminal install program;
(e2) generating the secret key on the basis of the hardware setting information thereof by the key generation algorithm of the mobile communication terminal install program;
(e3) decrypting the downloaded encrypted program with the generated secret key by the decryption program of a mobile communication terminal install program; and
(e4) installing the decrypted program by the mobile communication terminal install program.

3. The method as set forth in claim 1, wherein the secret key and the public key generated on the basis of the hardware setting information unique to the mobile communication terminal are fixed.

4. The method as set forth in claim 1, wherein the hardware setting information is a unique terminal identification number unique to the mobile communication terminal.

5. The method as set forth in claim 4, wherein the unique terminal identification number is an international mobile equipment identity (IMEI), and the IMEI includes a TAC (Type Approval Code) that represents information about type approval of the corresponding terminal, an FAC (Final Assembly Code) that identifies a company, which produces the corresponding terminal, an SNR (Serial NumbeR) that is a unique serial number of the corresponding terminal, and a CD (Check Digit) that is used to check presence/absence an error in the unique terminal identification number.

6. The method as set forth in claim 1, wherein the key generation algorithm is an EC-KCDSA asymmetric encryption/decryption algorithm.

7. The method as set forth in claim 1, wherein the mobile communication terminal is an SDR terminal.

8. A method of protecting illegal program copy of a mobile communication terminal, the method comprising the steps of:
(a) causing a program download server to receive a request to download a program from the mobile communication terminal;
(b) causing the program download server to receive a public key, which is generated on the basis of hardware setting information of the mobile communication terminal, from a key registration server;
(c) causing the program download server to encrypt the program requested by the mobile communication terminal with the received public key; and
(d) causing the program download server to transmit the encrypted program to the mobile communication terminal.

9. An apparatus for protecting illegal program copy of a mobile communication terminal, the apparatus comprising:
a key generation algorithm unit that reads hardware setting information of the mobile communication terminal, and generates a secret key and a public key on the basis of the read hardware setting information;
a key registration unit that registers the generated public key in a key registration server; and
a decryption unit that decrypts a program, which is encrypted with the public key registered in the key registration server and downloaded from the program download server, with the generated secret key.

10. The apparatus as set forth in claim 9, wherein the program includes program codes and installation configuration information.

11. The apparatus as set forth in claim 9, wherein the mobile communication terminal is an SDR terminal.
